(19) United States
(12) Patent Application Publication
(10) Pub. No.: US 2026/0267995 A1
(43) Pub. Date: Sep. 10, 2026

(54) Methods and Systems for Correlating Security Vulnerabilities with Exposure Paths

(71) Applicant: Veriti Security LTD., Tel Aviv (IL)

(72) Inventors: David ZILBERBERG, Petah Tikva (IL); Ido NITSAN, Tel Aviv (IL); Oren KOREN, Petah Tikva (IL); Adi IKAN, Ra'anana (IL)

(21) Appl. No.: 19/328,167

(22) Filed: Sep. 14, 2025

Related U.S. Application Data
(60) Provisional application No. 63/766,561, filed on Mar. 4, 2025.

(51) Int. Cl. G06F 21/57

(52) U.S. Cl. CPC G06F 21/577; G06F 2221/034

(57) ABSTRACT

A computer-implemented method obtains client data and vendor data. The vendor data includes Common Vulnerabilities and Exposures (CVE) data, adversary tactics data, and threat actor data. A CVE of the CVE data is semantically correlated with client applications of the client data to identify at least one client application vulnerable to exploitation attempts of the CVE. The CVE is semantically correlated with adversary tactics of the adversary tactics data to identify at least one adversary tactic used to exploit the at least one client application. The at least one adversary tactic is semantically correlated with threat actors of the threat actor data to identify at least one threat actor that utilizes the at least one adversary tactic, thereby identifying at least one exposure path from a threat actor to a vulnerable client application. A remediation roadmap is then generated for the client based on the at least one exposure path.

### CROSS-REFERENCE TO RELATED APPLICATIONS

This application claims priority from U.S. Provisional Patent Application No. 63/766,561, filed Mar. 4, 2025, whose disclosure is incorporated by reference in its entirety herein.

### TECHNICAL FIELD

The present disclosure relates to cybersecurity and, more particularly, but not exclusively, to correlating security vulnerabilities with security risks such as exposure paths.

### BACKGROUND OF THE DISCLOSURE

The rapidly evolving landscape of cybersecurity presents organizations with increasingly complex challenges in safeguarding their software infrastructure. Vulnerabilities can exist in software due to unsecure coding practices that can lead to unanticipated behavior. Adversaries can take advantage of security vulnerabilities through targeted exploitation. Effective vulnerability management requires not only detecting potential weaknesses in these components but also assessing their exploitability, prioritizing remediation efforts, and reducing exposure to potential threats.

Security vulnerability assessments may be conducted to enhance cybersecurity of organizations. Vulnerabilities may comprise software flaws or potential software weaknesses that could be targeted by attackers. In some cases, security vulnerability assessments may be suboptimal in one or more aspects. For example, traditional methods for security vulnerability assessment may suffer from a high ratio of false positives, in which listed vulnerabilities are irrelevant and have a low risk of being exploited.

In many cases, security vulnerabilities within an organization may not be associated with actual threats, creating a significant gap in cybersecurity. For example, a software application may have security vulnerabilities that can be exploited by unauthorized entities using certain exploit paths, such as system misconfigurations, open ports, or unauthorized access points. However, in case such exploit paths are not available, are not used by any threat actors, or the like, the risk for such exploitations may be low to non-existent.

In addition, conventional vulnerability assessment techniques may not differentiate between theoretical vulnerabilities and real, exploitable risks, such as security vulnerabilities for which exploitation attempts were made. For example, in case threat actors made certain exploitation attempts in order to exploit a vulnerability of a digital asset, the vulnerability may represent a highly probable real-world risk.

Furthermore, conventional vulnerability assessment techniques rely on vendor data from various vendors, including the National Vulnerability Database (NVD), adversary tactics databases such as the MITRE ATT&CK database, threat actor databases, or the like, which may provide their vendor data in different and possibly unstructured formats, such as using natural language text, which may be challenging to process automatically to gain insights. For example, each vendor source may output text using different structures, formats, or the like.

### SUMMARY OF THE DISCLOSURE

The present disclosed subject matter, also referred to herein as the disclosure, includes systems, methods, and computer program products for, among other things, correlating security vulnerabilities with security risks such as exposure paths.

According to certain some exemplary embodiments of certain aspects of the present disclosure, a security vulnerability assessment may be performed for a client having one or more digital products, applications, software infrastructure, or any other digital asset, all of which referred to herein as “applications” or “client applications”. In some exemplary embodiments, a security vulnerability assessment may map known vulnerabilities such as Common Vulnerabilities and Exposures (CVEs) to applications of the clients, libraries thereof, packages thereof, or the like, such as according to one or more vendor databases. CVEs may comprise publicly disclosed weaknesses in software, hardware, or the like, that can be exploited by attackers.

For example, CVEs may be retrieved or provided from vendors such as the NVD and mapped to client applications, according to mapping data from the NVD. The NVD may map vulnerabilities to specific functions, packages, libraries, software versions, operating systems, hardware impacted by the vulnerability, or the like. The NVD may offer severity ratings, or Common Vulnerability Scoring System (CVSS) scores, for various vulnerabilities.

In some cases, the data offered by vendors such as the NVD may be general, incomplete, and may have data gaps. For example, vendor data may not specify whether a CVE in a client application is likely to be targeted by any attackers, which specific attackers are likely to exploit the CVE, what types of attacks or adversary tactics are anticipated in such exploitation (such as MITRE ATT&CK techniques), or similar details. This lack of correlation between a CVE and its likely attacks can result in inaccurate CVSS scores, inaccurate security vulnerability assessments, inaccurate prioritizing of risks, or the like. It may be desired to overcome such data gaps and to map CVEs of an application to adversary tactics that can be used by likely attackers.

Certain aspects of the present disclosure leverage one or more language model, such as one or more large language model (LLM), to semantically bridge data gaps and identify actual exposure paths of CVEs. In some exemplary embodiments, through LLM-driven analysis, CVE data may be semantically linked and correlated to specific client applications that are vulnerable thereto, likely adversary tactics, and likely threat actors, thereby providing a holistic view of security exposures as well as their possible remediations. According to certain exemplary embodiments, linking vulnerabilities of a client to real world exposure paths, such as exposure paths that were targeted by threat actors, may bridge data gaps and enhance cybersecurity defense strategies.

In certain exemplary embodiments, in order to differentiate between theoretical vulnerabilities and real exploitable risks, a direct link may be identified between vulnerable client applications and their exposure paths. For example, an exposure path targeting an application may comprise exploitation methods or adversary tactics used by likely threat actors in order to target the client application.

According to certain exemplary embodiments, vendor data may be retrieved and/or accumulated from a plurality of sources. For example, vendor data may be retrieved from public vendors, private vendors, or the like.

In certain exemplary embodiments, for each client, CVEs of their client applications may be retrieved or extracted from vendors such as NVD. For example, an Application Programming Interface (API) call may be invoked to query the NVD with identifiers of digital assets of the client such as a name of a software library, package, application, or the like, and obtain from the NVD in return a list of corresponding CVEs. In some cases, the NVD may deploy a scheme such as a Common Platform Enumeration (CPE) scheme to map CVEs to specific assets such as software or hardware products. For example, the CPE may provide, for an application indicated by an API call, a machine-readable identifier of a CVE entry that affects the application, a human-readable identifier of the CVE, or the like. In some cases, a mapping of client applications to CVEs may be obtained via API calls, messages, or any other communication methods.

According to certain exemplary embodiments, vendors such as NVD may collect general data about CVEs, such as which protections of various vendors are associated with CVEs, which applications can be exploited using CVEs, or the like. In some exemplary embodiments, client applications associated with the requested CVE may be retrieved from the NVD together with CVE data, such as the general data regarding the CVE.

In certain exemplary embodiments, for each CVE of a client application that is retrieved from the NVD, threat actors that are relevant to the CVE may be retrieved from one or more databases associated with threat actors, referred to as “Vendors Intelligence” sources. In some cases, Vendors Intelligence sources may comprise organizations that provide intelligence or general data regarding threat actors, attack groups, or the like. In some exemplary embodiments, data regarding threat actors may be represented as Advanced Persistent Threat (APT) activities, e.g., by the vendors.

For example, Vendors Intelligence sources such as CrowdStrike™, Microsoft™, Check Point™, or the like, may maintain databases (DBs) regarding attack groups such as APT28, APT29, Lazarus Group, DragonOK, Confucius, or the like, their typical activities, their typical behaviors, and their typical tactics. The data may comprise up-to-date APTs data such as the names of the attack groups, tracked behaviors and tactics of the attack groups, reported tactics of the attack groups such as related MITRE ATT&CK techniques, Indicators of Compromise (IoCs), or the like.

According to certain exemplary embodiments, Vendors Intelligence sources may be leveraged to fetch, for a requested CVE, the respective threat actors that typically exploit the CVE. For example, a Vendors Intelligence source may be queried via an API call with a vulnerability identifier such as a name of a CVE, a CVE identifier, or the like. In response, the Vendors Intelligence source may provide a list of corresponding threat actors, or APTs, associated with the CVE. In some exemplary embodiments, APTs may be considered to be associated with a CVE in case they are known to have previously exploited the CVE, in case they are known to typically attempt to exploit the CVE, in case worldwide attempts by the threat actors were previously detected and recorded, in case the actors are capable of exploiting the CVE, or the like.

In certain exemplary embodiments, for each threat actor retrieved from the Vendors Intelligence sources, adversary tactics that are likely to be used by the threat actor may be extracted and retrieved from one or more adversary tactics DBs, such as the MITRE ATT&CK™ DB. For example, MITRE ATT&CK may maintain a database or repository that correlates threat actors such as APTs, with attack types, e.g., Tactics, Techniques, and Procedures (TTPs). The attack types may also be referred to as “adversary tactics”, TTPs, or the like.

For example, an API call may be invoked to query MITRE ATT&CK with an identifier of a threat actor such as a name of a threat actor, a machine-readable identifier thereof, or the like, and obtain from MITRE ATT&CK in return a list of corresponding TTPs. In some exemplary embodiments, TTPs that are identified for a threat actor may comprise tactics, techniques, or procedures that are expected to be used by the threat actor. For example, a TTP may be considered to be associated to a threat actor in case the threat actor is known to have attempted to utilize the TTP for attacks, in case the threat actor is expected to utilize the TTP for attacks, in case recorded TTP attacks by the threat actor were previously detected, or the like.

According to certain exemplary embodiments, the accumulated vendor data retrieved, for one or more client applications, from vendors such as NVD, MITRE ATT&CK, CrowdStrike™, Microsoft™ and Check Point™ may enable the client to map CVEs of the client applications to threat actors, and to map threat actors to TTPs, but may not enable to bridge the gap between the CVEs and the TTPs.

For example, in case a CVE of a client application is mapped to a threat actor such as DragonOK, and the threat actor is mapped to sixty adversary tactics or TTPs, many of the TTPs of DragonOK may not be relevant to the CVE, and cannot be used to exploit the CVE in any attempted attack. For example, in case the CVE is a post-exploitation technique such as a privilege escalation vulnerability, and the TTPs of DragonOK comprise an initial access technique such as the Spear-phishing technique that is configured to lure victims via email attachments or links, the Spear-phishing technique may not be relevant for exploiting the CVE.

In certain exemplary embodiments, the data gap may be overcome by leveraging one or more language models to intersect the vendor data with client data, and perform a structured semantic analysis of the combined data, e.g., as depicted in FIGS. 2-5. In some exemplary embodiments, the semantic analysis may be used to map CVEs to the adversary tactics.

In certain exemplary embodiments, the client data may comprise, for each client, security logs, system logs, configuration files, configuration settings, a list of client applications, components of the client applications, or the like. In some exemplary embodiments, the client data may reflect actual attempts, or false positive identifications of attempts, of threat acts to attack the client's applications. For example, the client data may reflect TTPs utilized by a threat actor to exploit a CVE.

According to certain exemplary embodiments, language models such as machine learning algorithms, advanced algorithms, heuristics-based algorithms, or the like, may possess semantic analysis and text generation capabilities, making them suitable for providing content-aware output based on textual inputs. For example, language models may comprise machine learning models trained on vast amounts of textual data, enabling them to comprehend semantic meanings of text and to generate meaningful text according to input instructions. These models employ deep neural network architectures to learn patterns, semantics, and contextual information from textual inputs.

In certain exemplary embodiments, the language models may comprise one or more Artificial Intelligence (AI) language models, such as Large Language Models (LLMs), Small Language Models (SLMs), a Generative AI models (GAIMs), Machine Learning (ML) models, or the like, which may or may not be combined with one or more heuristic engines, Natural Language Processing (NLP) models, or the like. In some exemplary embodiments, a language model such as an LLM engine may comprise a private LLM, a public LLM such as public Generative Pre-trained Transformers (GPTs), a public LLM that is retrained on a private dataset such as an internal knowledge base, an on-premises LLM, or the like. For example, LLM engines may comprise engines of ChatGPT™, BARD™, Deepseek™, BING™ Chat, or the like. By leveraging their vast knowledge base and language proficiency, language models such as LLMs can be used to perform semantic tasks such as content generation, language understanding, and context extraction, among others. In other cases, any other algorithms and/or machine learning models may be used.

According to certain exemplary embodiments, one or more language models may be utilized to ingest security-related data of a client, including the vendor data, client data, or the like. In some exemplary embodiments, the language models may be utilized as part of a data integration module that is configured to ingest data from different sources in order to generate based thereon structured and/or uniform data. For example, the data integration module may be configured to ingest vendor data obtained from Threat Intelligence databases, vulnerability databases such as the NVD, adversary tactics databases such as MITRE ATT&CK, or the like, which may be at least partially non-uniform, unstructured, or the like. In some cases, the data integration module may normalize data between API calls.

In certain exemplary embodiments, the data integration module may be configured to parse unstructured or non-uniform data in various formats from various sources, such as free-text incident reports, vendor bulletins, or the like, and extract key information and relevant fields therefrom. In some exemplary embodiments, the data integration module may normalize the extracted data, such as by mapping extracted terms to a standardized vocabulary, converting the data to a common format, standardizing terms under one unified label, or the like. For example, the data integration module may employ one or more normalization algorithms to normalize and unify the data. In some exemplary embodiments, the data integration module may output structured data with an identical format.

According to certain exemplary embodiments, after ingesting and normalizing the data, a threat correlation engine may be employed to process the security-related data from all sources. In some exemplary embodiments, the threat correlation engine may comprise a plurality of models configured to process the client data. In some exemplary embodiments, each model may comprise one or more different or same language model engines, that are tasked with a specific semantic analysis task. For example, each model may comprise a cluster of two or more different language models, such as ChatGPT™, BARD™, and Deepseek™ LLM engines, each of which being trained on different training sets. In some exemplary embodiments, utilizing a cluster of different language model to perform a semantic analysis task separately by each engine, may enable to enhance the precision and efficiency of the task, compared to using one or more identical LLM engines.

In some cases, each model of the threat correlation engine may utilize a different disjoint cluster of language models, e.g., simultaneously. In some cases, all models may utilize the same cluster of language models, e.g., sequentially. In some cases, at least some language models of a cluster may be utilized for more than one model of the threat correlation engine.

In certain exemplary embodiments, each model of the threat correlation engine may be exploited, utilized, fine-tuned, or the like, to perform a different semantic analysis task on the ingested data, e.g., as described in the description of FIGS. 1 and 2. For example, a first model may be configured to link or find meaningful connections between vulnerabilities and client applications that were affected thereby, e.g., as depicted in FIG. 3. As another example, a second model may be configured to link or find meaningful connections between vulnerabilities and adversary tactics, e.g., as depicted in FIG. 4. As another example, a third model may be configured to link or find meaningful connections between adversary tactics and real-world threat actors, e.g., as depicted in FIG. 5.

According to certain exemplary embodiments, the outputs of the different models may represent which client applications were affected by exploitation attempts of each vulnerability, an estimation of which TTPs were used for each exploitation attempt, and an estimation of which threat actors were behind the TTPs. In some exemplary embodiments, a path from a CVE of an application, to its TTP and APT may be referred to as an “exposure path”. For example, an exposure path may represent one or more successful exploitation attempts, unsuccessful exploitation attempts, false positives identifications of exploitation attempts (by configurations or security systems executed on client devices), or the like. In some cases, each CVE of the client applications may be linked to its exposure paths, e.g., the expected exploitation attacks, the expected threat actors, or the like.

In certain exemplary embodiments, a remediation roadmap is generated by feeding the outputs from the different models to a trained machine learning model, AI model, deep learning model, or the like, referred to herein as the “remediation model”. In some exemplary embodiments, the trained remediation model may be configured to match identified exposure paths with remediation steps. In some exemplary embodiments, the remediation model may generate a remediation roadmap or report, presenting for each CVE used by an exposure path, one or more applicable remediations such as remediation suggestions, automatic remediations, or the like.

For example, the remediation roadmap may comprise a security vulnerability assessment that is generated for each client, and is processed to reflect identified exposure paths. According to this example, the vulnerability assessment may be generated to filter out or remove CVEs of client application that are not incorporated in any exposure path, that are not incorporated in a significant number or type of exposure paths, or the like. According to this example, the vulnerability assessment may be generated to adjust the severity scores of CVEs, as obtained from the NVD, according to their identified exposure paths, the severity of the exposure paths, the frequency of exploitation attempts thereof, or the like.

According to certain exemplary embodiments, by integrating the outputs of the different models, comprehensive and unified view of the security landscape, including full exposure paths, can be achieved. In some exemplary embodiments, this interlinked approach ensures a deeper understanding of how vulnerabilities are exploited, by what adversary tactics and real-world threat actors, enabling organizations to prioritize critical risks and address them with precision.

In certain exemplary embodiments, in addition to generating the remediation roadmap, the revealed exposure paths may enable clients to handle active security breaches in real-time or near real-time. In some exemplary embodiments, real time attack detections of exploitations may be performed in view of security logs that are accumulated in real time, such as recent Intrusion Prevention System (IPS) logs, and those may be automatically correlated to remediations, thereby enabling to mitigate the attacks.

Another aspect of the present disclosure provides creation of a smooth and seamless integration of different vendor data with each other, of vendor data with client data, or the like, and to bridge the data gap between them. In some exemplary embodiments, based on the ingestion and integration of multiple data sources, the disclosed subject matter enables to process and extract the exposure paths of CVEs of digital assets of a client.

A further aspect of the present disclosure provides clients the ability to direct their resources toward the most pressing security exposures, instead of relying on severity scores of vulnerabilities that may not be correlated to actual exposure paths. For example, vulnerabilities of an application that are not reflected in any exposure paths in the client data, may be filtered out from the application's security vulnerability assessments, may be generated with a reduced severity score, made less salient, or the like, thereby minimizing unnecessary computational overhead of clients.

According to certain exemplary embodiments, correlating vulnerabilities to exposure paths enables clients to focus on actual, exploitable threats by filtering out theoretical or non-actionable risks. In some exemplary embodiments, through this enriched correlation and context, the disclosed subject matter enables clients to identify which of its applications are truly at risk, how they can be exploited, and by which threat actors. In some exemplary embodiments, based on the identified real threats, a precise prioritized actionable remediation plan may be generated, to address the most critical security gaps first, improving risk management efficiency and strategic risk reduction. In some cases, the prioritized actionable remediation plan may enable clients to align with regulatory standards by ensuring the most significant vulnerabilities are addressed promptly.

Yet another aspect of the present disclosure provides enhancement of posture management by enabling clients to streamline their remediations for maximum impact on overall security posture. For example, using the disclosed subject matter, clients may be provided with an actionable remediation plan, enabling them to prioritize and address the most critical security issues efficiently, ensuring that their remediations have the greatest impact on reducing overall risk and improving security resilience. The actionable remediation plan may comprise a user-tailored, targeted and prioritized remediation strategy that optimizes resource allocation and enhances risk management.

A further aspect of the present disclosure provides real-time or near real-time recommendations for handling active breaches. In some exemplary embodiments, basing the identification of exposure paths on security logs that are accumulated in real time, enables to find and address active security breaches in real time, e.g., as part of an Automatic Incident Response (AIR) system of the client.

Yet another aspect of the present disclosure provides semantic linking of vulnerabilities to adversary tactics, which was previously infeasible and bridges a crucial gap in cybersecurity. By linking existing exposure paths in an organization to its CVEs, the cybersecurity defense strategies that rely on CVE information may be enhanced. In some exemplary embodiments, this interlinked approach ensures a deeper understanding of how vulnerabilities are exploited, enabling organizations to act with precision on critical risks. The disclosed subject matter may provide for one or more technical improvements over any pre-existing technique and any technique that has previously become routine or conventional in the art. Additional technical problem, solution and effects may be apparent to a person of ordinary skill in the art in view of the present disclosure.

Embodiments of the present disclosure are directed to a computer-implemented method. The method comprises: obtaining vendor data comprising Common Vulnerabilities and Exposures (CVE) data, adversary tactics data, and threat actor data; obtaining client data of a client; semantically correlating a CVE of the CVE data with client applications of the client data to identify at least one client application vulnerable to exploitation attempts of the CVE; semantically correlating the CVE with adversary tactics of the adversary tactics data to identify at least one adversary tactic used to exploit the at least one client application; semantically correlating the at least one adversary tactic with threat actors of the threat actor data to identify at least one threat actor that utilizes the at least one adversary tactic, thereby identifying at least one exposure path from a threat actor to a vulnerable client application; and generating a remediation roadmap for the client based on the at least one exposure path.

Optionally, at least one of the semantically correlating is performed by a threat correlation engine comprising a plurality of language models, each language model of the plurality of language models being a cluster of language models.

Optionally, at least one of the semantically correlating is performed by intersecting results from the plurality of language models to obtain a final result.

Optionally, at least one of the semantically correlating is performed by a plurality of language models using a prompting technique, and the language models are provided with a prompt comprising contextual data from the vendor data and the client data.

Optionally, at least one of the semantically correlating is performed by a plurality of language models using an embedding technique, the embedding technique including: converting textual data from at least one of the vendor data or the client data into a numerical vector, and performing a semantic similarity search of the numerical vector to identify a contextual matching.

Optionally, the client data includes one or more of security logs, system logs, configuration files, configuration settings, a list of client applications, or components of client applications.

Optionally, the vendor data is obtained from at least one of an NVD database, a MITRE ATT&CK database, or a Vendors Intelligence database.

Optionally, the remediation roadmap is generated based on a prioritization process that assigns a risk score to the at least one exposure path.

Optionally, the prioritization process is performed by a remediation model that uses a cost function, the cost function taking into account a severity of the CVE, an importance of the at least one client application, and a likelihood of exploitation.

Optionally, the prioritization process further includes filtering out exposure paths that have a risk score below a predetermined threshold.

Optionally, the method further comprises: optimizing resource allocation for remediations, using an optimizer to globally minimize the cost of the remediations.

Optionally, the method further comprises: filtering out an exposure path that is not relevant in view of security controls and configurations of the client.

Embodiments of the present disclosure are directed to a computer system. The computer system comprises: a computerized processor; and a non-transitory storage medium for storing instructions that, when executed by the computerized processor, cause the system to: obtain vendor data comprising Common Vulnerabilities and Exposures (CVE) data, adversary tactics data, and threat actor data, obtain client data of a client, semantically correlate a CVE of the CVE data with client applications of the client data to identify at least one client application vulnerable to exploitation attempts of the CVE, semantically correlate the CVE with adversary tactics of the adversary tactics data to identify at least one adversary tactic used to exploit the at least one client application, semantically correlate the at least one adversary tactic with threat actors of the threat actor data to identify at least one threat actor that utilizes the at least one adversary tactic, thereby identifying at least one exposure path from a threat actor to a vulnerable client application, and generate a remediation roadmap for the client based on the at least one exposure path.

Optionally, the non-transitory storage medium stores instructions for a threat correlation engine comprising a plurality of language models, such that when executed by the computerized processor, a first model of the threat correlation engine semantically correlates the CVE with the client applications, a second model of the threat correlation engine semantically correlates the CVE with the adversary tactics, and a third model of the threat correlation engine semantically correlates the at least one adversary tactic with the threat actors.

Optionally, the first, second, and third language models each include a cluster of language models.

Optionally, the first, second, and third language models is each configured to be provided with a prompt comprising contextual data from the vendor data and the client data, and the first, second, and third language models is each configured to perform sematic correlation using a prompting technique.

Optionally, the first, second, and third language models is each configured to perform sematic correlation by: converting textual data from at least one of the vendor data or the client data into a numerical vector, and performing a semantic similarity search of the numerical vector to identify a contextual matching.

Optionally, the non-transitory storage medium stores instructions for a threat correlation engine comprising a remediation model, such that when executed by the computerized processor, the remediation model generates the remediation roadmap.

Optionally, the remediation model is further configured to perform a prioritization process that assigns a risk score to the at least one exposure path, and to generate the remediation roadmap based on the prioritization process.

Embodiments of the present disclosure are directed to a computer usable non-transitory storage medium having a computer program embodied thereon for causing a suitably programmed system to perform the following steps when such program is executed on the system, the steps comprising: obtaining vendor data comprising Common Vulnerabilities and Exposures (CVE) data, adversary tactics data, and threat actor data; obtaining client data of a client; semantically correlating a CVE of the CVE data with client applications of the client data to identify at least one client application vulnerable to exploitation attempts of the CVE; semantically correlating the CVE with adversary tactics of the adversary tactics data to identify at least one adversary tactic used to exploit the at least one client application; semantically correlating the at least one adversary tactic with threat actors of the threat actor data to identify at least one threat actor that utilizes the at least one adversary tactic, thereby identifying at least one exposure path from a threat actor to a vulnerable client application; and generating a remediation roadmap for the client based on the at least one exposure path.

Unless otherwise defined herein, all technical and/or scientific terms used herein have the same meaning as commonly understood by one of ordinary skill in the art to which the disclosure pertains. Although methods and materials similar or equivalent to those described herein may be used in the practice or testing of embodiments of the disclosure, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the present disclosure are herein described, by way of example only, with reference to the accompanying drawings. With specific reference to the drawings in detail, it is stressed that the particulars shown are by way of example and for purposes of illustrative discussion of embodiments of the disclosure. In this regard, the description taken with the drawings makes apparent to those skilled in the art how embodiments of the disclosure may be practiced.

Attention is now directed to the drawings, where like reference numerals or characters indicate corresponding or like components. In the drawings:

FIG. 1 is a flow diagram illustrating a method for correlating security vulnerabilities with security risks, according to embodiments of the present disclosure;

FIG. 2 is a diagram illustrating data flow for the method of FIG. 1, according to embodiments of the present disclosure;

FIG. 3 is a data flow diagram of an exemplary model used for mapping CVE data to client application data, for example as part of the method of FIG. 1, according to embodiments of the present disclosure;

FIG. 4 is a data flow diagram of an exemplary model used for mapping CVE data to adversary tactics, for example as part of the method of FIG. 1, according to embodiments of the present disclosure;

FIG. 5 is a data flow diagram of an exemplary model for mapping adversary tactics to threat actors, for example as part of the method of FIG. 1, according to embodiments of the present disclosure; and

FIG. 6 is a block diagram of an architecture of an exemplary system according to an embodiment of the present disclosure.

### DESCRIPTION OF THE PREFERRED EMBODIMENTS

The present disclosure is directed to systems, methods, and computer program products for, among other things, determining remediations for suspected threats.

Before explaining at least one embodiment of the disclosure in detail, it is to be understood that the disclosure is not necessarily limited in its application to the details of construction and the arrangement of the components and/or methods set forth in the following description and/or illustrated in the drawings and/or the examples. The disclosure is capable of other embodiments or of being practiced or carried out in various ways.

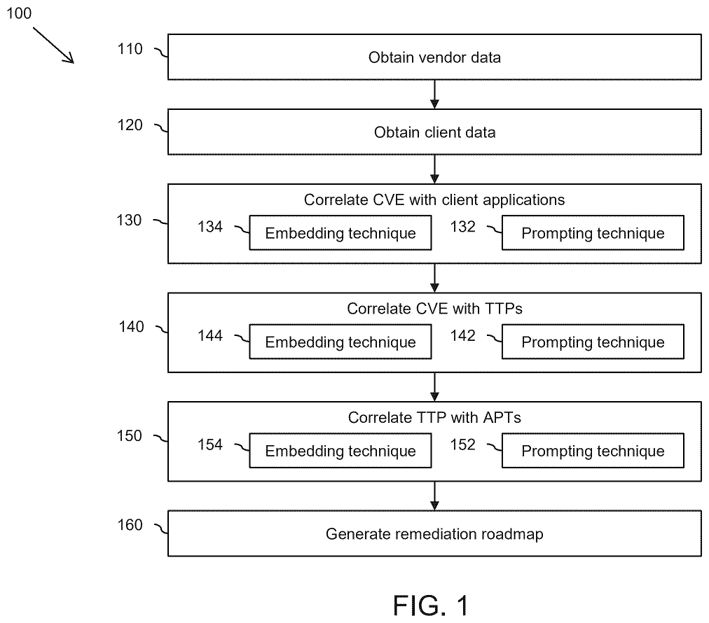

Referring now to the drawings, reference is made to FIG. 1, which illustrates a flow diagram of a computer-implemented method 100, in accordance with some exemplary embodiments of the disclosed subject matter. This computer-implemented method includes an algorithm for, among other things, correlating security vulnerabilities with security risks such as exposure paths. The method (i.e., its steps and sub-steps) are for example, performed automatically, but can be, for example, performed manually, and are performed, for example, in real time.

At step 110, vendor data may be obtained. In some exemplary embodiments, the vendor data may comprise CVE data per client application from vendors such as NVD, threat actor (APT) data composed of threat actors (ATPs) per CVE from vendors such as Vendors Intelligence sources, adversary tactics (TTP) data composed of adversary tactics (TTPs) per threat actor (ATP) from vendors such as MITRE ATT&CK, or the like. In some exemplary embodiments, the vendor data may be obtained via API calls, messages, requests, or the like. In some exemplary embodiments, the vendor databases may be publicly available, private, or the like.

At step 120, client data of a client may be obtained, for example directly from the client or via an intermediary. For example, the client data may be obtained from Security Information and Event Management (SIEM) Systems of a client, from cloud storage services, from log analytics services, from on-premises log servers, from syslog servers, from log management tools, from third-party security providers of the client, or the like.

In certain exemplary embodiments, the client data may comprise, for each client, security logs, system logs, configuration files, configuration settings, a list of client applications, Software Bill of Material (SBOM) of the client applications, components of the client applications, or the like. In some exemplary embodiments, the client data may be provided per application, for all client applications, or the like.

According to certain exemplary embodiments, each client application of a client may comprise a software application, a web-based application, a desktop application, a cloud-based application, firmware code, a database system, a software package, a software module, or the like. In some exemplary embodiments, an application may comprise a code base, which may be inspected for vulnerabilities. For example, a security vulnerability assessment may be generated for the application by a third party and adjusted by the disclosed subject matter, a security vulnerability assessment may be generated from scratch by the disclosed subject matter, or the like.

In certain exemplary embodiments, a threat correlation engine may employ one or more artificial intelligence model, machine learning models, algorithm, or the like, to identify exposure paths that link exposures to vulnerabilities. In some exemplary embodiments, the threat correlation engine may be configured to establish semantic connections between theoretical security vulnerabilities of an application, e.g., CVEs representing publicly disclosed weaknesses in software, and their actual exposure paths through LLM-driven analysis, AI-driven analysis, or the like.

According to certain exemplary embodiments, in order to differentiate between theoretical vulnerabilities and real-world exposure paths, CVEs of client applications may be correlated to real-world adversary tactics and threat actors, to provide a unified security landscape view. In some exemplary embodiments, exposure paths may comprise a path starting at a threat actor, using an adversary tactic to exploit a CVE of a client application. In some exemplary embodiments, the threat correlation engine may be configured to semantically link and correlate CVE data to client applications vulnerable thereto, adversary tactics exploiting the CVE to gain access to a vulnerable client application, threat actors utilizing the adversary tactics, or the like, e.g., at steps 130-150. In some exemplary embodiments, the threat correlation engine may perform the correlation using the vendor data obtained at step 110 and the client data obtained at step 120, in order to perform a full semantic analysis using a plurality of models.

In certain exemplary embodiments, the threat correlation engine may be configured to establish bidirectional semantic links. For example, at step 130, the threat correlation engine may establish a semantic link or path from CVEs to specific client applications, thereby identifying the applications truly at risk. At steps 140-150, the threat correlation engine may establish a semantic link from CVEs to TTPs and known threat actors, thereby revealing realistic exploitation paths of client applications.

At step 130, a first model may be deployed by the threat correlation engine, in order to correlate a CVE of the CVE data with client applications (of the client data) to identify at least one client application vulnerable to exploitation attempts of the CVE. In some exemplary embodiments, the first model may comprise a cluster of language models such as LLMs.

According to certain exemplary embodiments, in order to identify exposure paths of a CVE, the CVE may be first correlated to client applications that were exploited by the CVE. In some exemplary embodiments, the first model may be configured to establish a semantic link or path from CVEs to specific client applications, thereby identifying the applications truly at risk.

In certain exemplary embodiments, in order to correlate a CVE with exploitations of client applications using the CVE, the cluster of the first model may be provided with the CVE data, enriched or augmented with contextual data from various sources, such as the client's security logs, the APTs correlated with the CVE, the TTPs correlated with each APT, or the like. For example, a prompt may be generated to incorporate such data therein, and the prompt may be provided to the cluster of the first model, thereby instructing the first model to estimates which client applications are most relevant to the CVE in view of attacks and attack attempts represented by the clients IPS logs. Each engine of the cluster may estimate which of the client assets were most attacked by exploiting the CVE.

According to certain exemplary embodiments, the first model may refine the accuracy and confidence of the cluster's output, such as by intersecting results from language models of the cluster. For example, in case the cluster comprises three different LLMs, the first model may intersect results from the three LLMs in order to determine what applications are at risk, for every existing CVE. For example, in case L₁, L₂, L₃ are the outputs of the three LLMs, the final intersected result, R, may be calculated as follows:

$$R = {L}_{1} ⋂ {L}_{2} ⋂ {L}_{3} \qquad ( 1 )$$

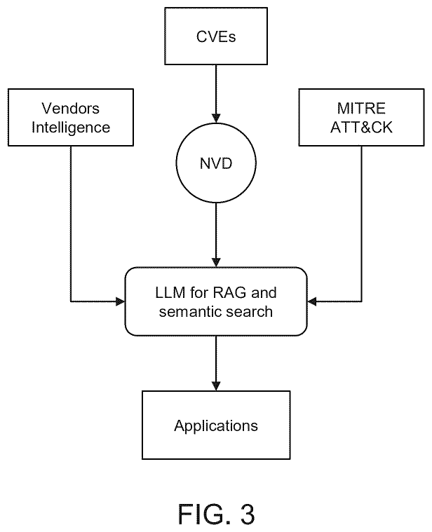

In certain exemplary embodiments, the first model may refine the accuracy and confidence of the cluster's output, such as by using different techniques to correlate the CVE exploitations in the client's logs with client applications. For example, the first model may utilize a Prompting Technique 132 and/or an Embedding Technique 134 (as part of step 130), e.g., as described with reference to FIG. 3, each of which being calculated separately by each language model of the cluster and intersected. According to this example, the outputs of the different techniques, such as R₁ and R₂ may be intersected, e.g., as follows:

$${R}_{final} = {R}_{1} ⋂ {R}_{2} \qquad ( 2 )$$

where R₁ and R₂ are calculated according to Equation 1 (as R of Equation 1), each using a different technique, and R_{final} is calculated as the intersection of R₁ and R₂. In other cases, any other number of techniques and corresponding outputs may be calculated and intersected similarly to Equation 2.

At step 140, a second model may be deployed by the threat correlation engine, in order to correlate the CVE of the CVE data to TTPs (of the adversary tactic data) to identify at least one adversary tactic (TTP) used to exploit the client application(s) vulnerable to the CVE, e.g., as identified at step 130. In some exemplary embodiments, the second model may comprise a cluster of language models such as LLMs, identical or at least partially separate from the cluster of the first model.

According to certain exemplary embodiments, the second model may be configured to establish a semantic link or path from CVEs to specific adversary tactics, in order to reveal the exposure paths of the CVE. For example, the second model may be configured to reveal semantic links from CVEs to TTPs from the MITRE ATT&CK.

In certain exemplary embodiments, in order to correlate CVE data with TTPs used to exploit the vulnerable client applications, the cluster of the second model may be provided with the CVE data, enriched or augmented with contextual data from various sources, such as the client's security logs, the APTs correlated with the CVE, the TTPs correlated with each APT, the vulnerable client applications detected for the CVE on step 130, or the like. For example, a prompt may be generated to incorporate such data therein, and the prompt may be provided to the cluster of the second model, thereby instructing the second model to estimates which TTPs were used to exploit the CVE when attacking the vulnerable client applications, in view of attacks and attack attempts represented by the client's security logs.

According to certain exemplary embodiments, the second model may refine the accuracy and confidence of the cluster's output, such as by intersecting results from language models of the cluster, e.g., similar to step 130. For example, in case the cluster comprises three different LLMs, the second model may intersect results from the three LLMs in order to determine which TTPs are used to exploit the vulnerable applications, for every existing CVE.

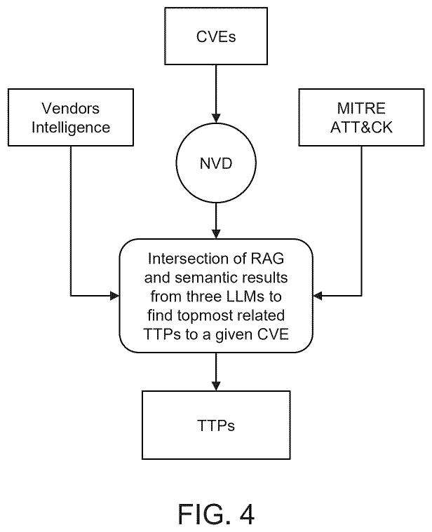

In certain exemplary embodiments, the second model may refine the accuracy and confidence of the cluster's output, such as by using different techniques to correlate the CVE exploitations in the client's logs with TTPs. For example, the second model may utilize a Prompting Technique 142 and/or an Embedding Technique 144 (as part of step 140), e.g., as described with reference to FIG. 4. In some exemplary embodiments, by mapping CVE data to TTPs from the MITRE ATT&CK, the second model may provide a direct link between the vulnerable applications and their exploitation methods.

At step 150, a third model may be deployed by the threat correlation engine, in order to correlate the adversary tactic(s) (TTPs) identified at step 140 with threat actors (APTs) (of the threat actor data) to identify at least one APT that utilizes the TTP(s) identified at step 140, and thereby identifying at least one exposure path from an APT to a vulnerable client application. In other words, in exemplary embodiments, the third model may enable to establish a semantic link or path from TTPs of a CVE to respective APTs, in order to reveal realistic exploitation (exposure) paths of the vulnerable client applications from APTs. For example, the full exposure path from CVEs, to TTPs and APTs may be revealed. In some exemplary embodiments, the third model may comprise a cluster of language models such as LLMs, identical or at least partially separate from the clusters of the first and second models.

According to certain exemplary embodiments, in order to correlate APTs with a TTP that was identified at step 140 to be associated with exploitations of at least one of the vulnerable client applications, the cluster of the third model may be provided with the TTP data, enriched or augmented with contextual data from various sources, such as the client's security logs, the CVE data, the APTs correlated with the CVE, the vulnerable client applications detected/identified for the CVE at step 130, or the like. For example, a prompt may be generated to incorporate such data therein, and the prompt may be provided to the cluster of the third model, thereby instructing the third model to estimates which APTs are behind the TTP, in view of attacks and attack attempts represented by the client's security logs.

In certain exemplary embodiments, the third model may refine the accuracy and confidence of the cluster's output, such as by intersecting results from language models of the cluster, e.g., similar to step 130. For example, in case the cluster comprises three different LLMs, the third model may intersect results from the three LLMs in order to determine possible APTs for the TTPs that are used to exploit the vulnerable applications, for every existing CVE.

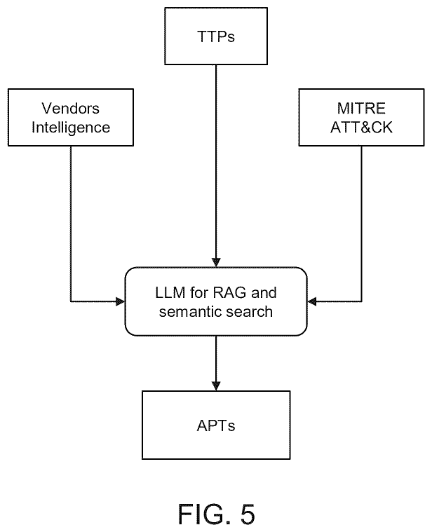

According to certain exemplary embodiments, the third model may refine the accuracy and confidence of the cluster's output, such as by using different techniques to correlate the TTP attack as reflected in the client's logs with APTs. For example, the third model may utilize a Prompting Technique 152 and/or an Embedding Technique 154 (as part of step 150), e.g., as described with reference to FIG. 5. In some exemplary embodiments, by mapping TTP data to APTs from Vendors Intelligence sources, the third model may complete the direct link between the vulnerable applications, their exploitation methods, and the adversaries most likely to target them.

At step 160, the threat correlation engine may process the revealed exposure paths between the vulnerable applications, their exploitation methods, and the adversaries most likely to target them, as identified using steps 130-150, in order to generate a remediation roadmap.

In certain exemplary embodiments, the threat correlation engine may generate a remediation roadmap, for assessing and prioritizing CVEs of client applications, according to the revealed exposure paths. In some exemplary embodiments, the remediation roadmap may advise security teams on the most urgent actions, time estimates, and resource allocation. In some exemplary embodiments, the threat correlation engine may use a remediation model, including one or more deep learning models, to prioritize threats, suggest remediations, or the like.

According to certain exemplary embodiments, a prioritization process of exposure paths may be performed, e.g., by the remediation model or any other processing unit, based on a cost function that takes into account the estimated value of the potential impact of one or more exposure paths on client applications, the severity of the CVE, the importance of the application to the client, the exploit likelihood, the criticality of the exposure path, resource requirements for the remediation, or the like. For example, risk scores or rankings may be assigned to threats such as exposure paths based on the above factors.

In certain exemplary embodiments, the prioritization process may be incorporated into an AI model, or calculated thereby. For example, the scoring may be performed as follows:

$$Risk Score = {\sum }_{i = 0}^{n} {w}_{i} {f}_{i} \qquad ( 3 )$$

where fᵢ represents the input factors such as the exposure path and client configurations that are inputted to the remediation model, and wᵢ represents learned weights that are assigned by the remediation model to the input factors at the inference stage.

According to certain exemplary embodiments, the calculated risk score may be generated for exposure paths, each including a combination of CVE data, application data, TTP data, and APT data (e.g., identifiers thereof). For example, in case the application affected by an exposure path is a mission-critical application, a high-severity CVE linked to the mission-critical application may be scored with a high priority. In some exemplary embodiments, the remediation roadmap may be generated based on the prioritization process, such as to include the top ten exposure paths, the top ten CVEs associated therewith, all exposure paths that are assigned a risk score greater than a threshold, or the like.

In certain exemplary embodiments, in case the calculated risk score of an exposure path is low, e.g., below a threshold, the exposure path may be considered irrelevant, insignificant, hypothetical, or the like, and may be filtered out from the roadmap. For example, the threat correlation engine may filter out irrelevant or hypothetical risks that are not relevant in view of the security controls and configurations of the client, e.g., in case the client's settings block an exposure path, in case the client is executing protection measures that block an exposure path, or the like. For example, an exposure path may be deemed to be an irrelevant or hypothetical risk, based on its assessed severity, exploit likelihood, and similar metrics.

For example, a vulnerability assessment may present a list of vulnerabilities such as Common Vulnerabilities and Exposures (CVE) vulnerabilities, a risk score of listed CVEs, or the like. According to this example, in case exposure paths that lead to a listed CVE are not existent (e.g., not found in the client data), have low priority, or the like, the vulnerability assessment may be adjusted to remove such vulnerabilities, reducing their risk score, or the like, thereby reducing false positives, reducing noise, and enabling security teams to focus on relevant vulnerabilities and perform informed decisions. In other cases, the vulnerability assessment may be generated from scratch to include only the high priority CVEs.

According to certain exemplary embodiments, the remediation model may provide one or more automated or suggested remediations for the prioritized exposures. In some exemplary embodiments, remediation plans may be provided for the remaining exposure paths that are not filtered out by the remediation model. For example, in case exposure paths representing contextualized threats of APTs, TTPs and applications are deemed relevant, the remediation roadmap may be generated to address these threats.

In certain exemplary embodiments, the remediation model may be trained on a dataset of remediations to exposure paths. In some exemplary embodiments, the remediation model may be configured to intersect exposure paths and the specific security controls and configurations of the client with remediations. For example, the dataset may comprise a database that is manually labeled to match remediations to CVEs and TTPs. In some exemplary embodiments, the dataset may be obtained from a third party, generated locally as an internal proprietary database, or the like.

According to certain exemplary embodiments, the remediation model may be trained to match the input data to respective remediations. For example, the input data may comprise exposure paths, such as tuples of CVE data, application data, TTP, and APT, alone or in combination with the additional client data, the client data used by the threat correlation engine such as the IPS logs, or the like. In some exemplary embodiments, the input data may be mapped to remediations, applicable solutions, or the like.

In certain exemplary embodiments, a remediation roadmap may be generated based on remediation suggestions of the remediation model. In some exemplary embodiments, the roadmap may be generated to indicate which exposure paths through CVEs are most critical, which CVEs are exposed by exposure paths and should be fixed, which CVEs are most urgent, what is the recommended remediation for the CVEs, or the like. For example, the roadmap may indicate which exposure path is most significant or harmful, remediations for the top exposure paths, or the like.

According to certain exemplary embodiments, the remediations may comprise applicable solutions such as suggested changes to client configuration, automated or suggested patch installation and execution, automated or suggested updates to security systems such as to a firewall version, or the like. For example, the applicable solutions may provide detailed instructions for mitigating each threat, such as patching, reconfiguring firewalls, disabling vulnerable services, applying mitigations, applying security controls such as network segmentation, retaining settings of endpoint protections that already neutralize the threat, or the like.

In some cases, an optimizer, such as a Constraint Satisfaction Problem (CSI), may be utilized to find the best resource allocation for remediations that globally minimized the cost of the remediations and the cost of estimated attacks while complying with a resource threshold of the client, with minimal security requirements, or the like. For example, an optimization function may measure what is the cost of remediating each exposure path, and determine an overall benefit of remediating each exposure path to obtain global optimization, such as using linear programming or CSP solvers.

For example, in case of limited resources, the optimizer may recommend not to remediate a high severity CVE, in case the remediation consumes more resources than required for remediating three lower severity CVEs, and the combined impact of the three lower severity CVEs is greater. As another example, the optimizer may recommend to use a suboptimal patch to remediate a CVE, in case the conserved resources can be used to remediate an additional CVE.

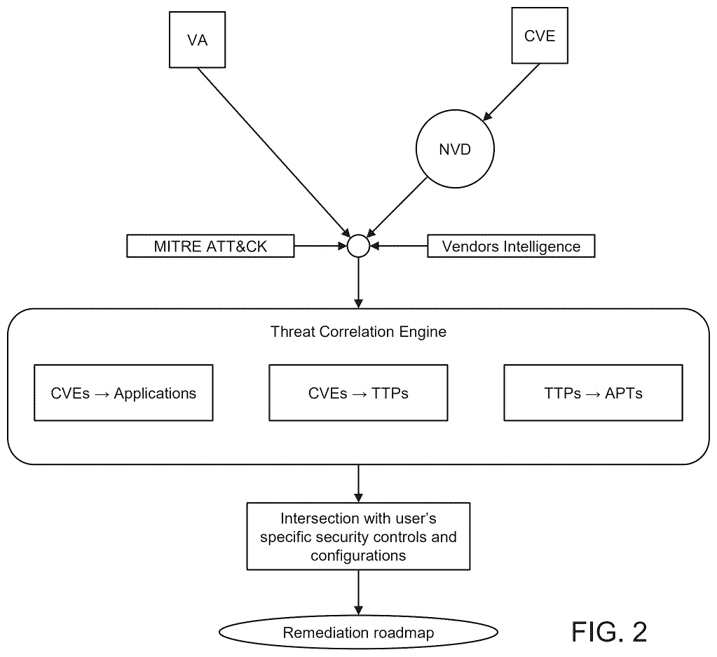

With continued reference to FIG. 1, refer now also to FIG. 2, which illustrates a data flow diagram, in accordance with some exemplary embodiments of the disclosed subject matter. Reference is also made to FIGS. 3-5.

In certain exemplary embodiments, as depicted in FIG. 2, the threat correlation engine obtains data (for example as part of step 110 of method 100) from a Vulnerability Assessment (VA) of a client (e.g., a third-party assessment), CVE data from NVD, threat actor data from Vendors Intelligence sources (denoted as “Vendors Intelligence”), adversary tactics from MITRE ATT&CK (denoted as “MITRE ATT&CK”), or the like. For example, using API calls, the threat correlation engine may extract APT data for each CVE, and TTP data for each APT found for the CVE.

In certain exemplary embodiments, the threat correlation engine may further obtain client data (for example as part of step 120 of method 100), such as security logs, security controls, system logs, configuration files, configuration settings, security configurations, a list of client applications, components of the client applications, or the like. For example, the client data may comprise IPS logs.

In certain exemplary embodiments, the threat correlation engine may employ a number of models, e.g., the models depicted in FIGS. 3-5, in order to reveal the exploitation path linking client vulnerabilities to actual security exposures. In some exemplary embodiments, each model may employ at least one language model cluster, including a plurality of language model engines, for their task. For example, the models of FIGS. 3-5 may be tasked with mapping CVE data to client applications that are most vulnerable to the CVE (for example as part of step 130 of method 100), mapping CVE data to adversary tactics most likely to exploit the CVE (for example as part of step 140 of method 100), and mapping the adversary tactics to threat actors most likely to implement the adversary tactics (for example as part of step 150 of method 100). For example, vulnerable applications may be mapped to adversary tactics, and to the adversaries most likely to target them.

According to certain exemplary embodiments, each model may intersect two or more language model techniques, such as an embedding technique and a prompting technique, in order to enhance the accuracy and confidence of the clusters' outputs.

In certain exemplary embodiments, the exposure path(s) output from the models may then be used by the remediation model of the threat correlation engine, optionally intersecting the exposure paths and the specific security controls and configurations of the client with remediations, to generate a remediation roadmap (for example as part of step 160 of method 100).

Referring now to FIG. 3, there is illustrated an exemplary model for mapping of CVE data to client application data, performed by the threat correlation engine (for example as part of step 130 of method 100).

In certain exemplary embodiments, it may be desired to perform an informed correlation of CVE data to client applications that are vulnerable thereto. For example, API calls to the NVD database may provide general associations between client applications and CVEs, representing which CVEs each client application has. However, such association may be general and may not reflect whether the CVEs of client applications were targeted in practice by any exploitation attempts by any threat actor. In some exemplary embodiments, CVEs of client applications may be considered targeted if it was attempted to be exploited by any TTP or threat actor.

According to certain exemplary embodiments, client applications for which attempted exploitations of a CVE were performed, may be considered more vulnerable to the CVE than other client applications. For example, the NVD database may indicate that first and second client applications are both vulnerable to a same CVE, but if attempted exploitations of the CVE were performed only with respect to the first application, the first application may be considered more vulnerable to the CVE than the second application.

In certain exemplary embodiments, the model of FIG. 3, also referred to as the “application model” may be configured to identify the vulnerable applications that were targeted in practice by exploitation attempts of the CVE. In some exemplary embodiments, in order to identify such client applications, the application model may utilize at least one language model cluster. For example, the cluster may comprise at least two general purpose LLMs, at least three general purpose LLMs, or the like, each of each being trained on a different dataset.

According to certain exemplary embodiments, each language model of the cluster may attempt to identify the vulnerable applications on its own, using one or more techniques, and the results of the different language models for each technique may be intersected to obtain enhanced results. In some exemplary embodiments, the techniques used by the language models may comprise a first technique also be referred to as the “prompting technique”, a second technique also be referred to as the “embedding technique”, or the like.

It is noted that although some of the figures, including FIG. 3, depict a specific number of LLMs in the cluster (three), the disclosure is not limited to such numbers and any other number of language models may be included within the cluster. In some cases, the models of FIGS. 3-5 may or may not include clusters with the same number of LLM engines.

In certain exemplary embodiments, when using the first prompting technique (denoted “semantic search” in FIG. 3), the application model may instruct a cluster of language models, using a defined prompt, to provide the most relevant client applications given contextual data such as a list of digital assets of the client, CVE data (extracted from the NVD), client data such as security logs, APT details that are extracted for the CVE from the Vendors Intelligence, and TTP details for each extracted APT, or the like. In some cases, the contextual data may comprise outputs from other models, such as TTPs identified for the CVE by the TTP model of FIG. 4, AP Ts identified for the CVE by the APT model of FIG. 5, or the like.

For example, each LLM engine of the cluster may be instructed to estimate which applications were targeted by attempts to exploit the CVE, given the contextual data. For example, each LLM engine of the cluster may be instructed to estimate, for an attack attempt or TTP associated with the CVE, which client applications (from the extracted applications from the NVD that are associated to the CVE) were most likely the target of the attack attempt.

According to certain exemplary embodiments, the list of digital assets of the client may comprise client applications, components of the client applications such as libraries and packages thereof, or the like. In some exemplary embodiments, the security logs of the client may comprise system logs, configuration files, configuration settings, IPS logs, or the like. For example, the client data may comprise action blocks of IPS logs. The action blocks may comprise sections of log entries that describe how the respective client devices responded to detected threats on the applications. For example, potential responds to threats may comprise allowing the traffic to proceed, generating an alert for detected suspicious activity without blocking it, blocking suspicious activity by preventing a packet, connection, or session, terminating the connection, isolating a source Internet Protocol (IP) address, file, or process for further analysis, limiting traffic from a suspicious source, or the like, and may be performed by one or more products executed on client devices, configurations of the devices, executed firewalls, or the like.

In certain exemplary embodiments, attempts of threat actors to exploit a CVE of a client application (using one or more TTPs) may be reflected in the security logs of the client, regardless of whether or not the attempt was successful. In some exemplary embodiments, the security logs of the client may in some cases reflect false positives, in which client applications responded to perceived threats that were in fact benign.

According to certain exemplary embodiments, each language model of the cluster may provide its own list of top applications, that are estimated to be the top target of exploitations of the CVE. Based on these individual lists, an overall selection of top applications for the entire cluster may be determined. For example, an average ranking or aggregation of the application lists from each LLM may be calculated to derive the overall cluster selection. In one scenario, each language model of the cluster may be configured to select at least a number of applications that complies with a threshold (e.g., at least 10 applications), to select all applications that score higher than a threshold (e.g., score above a threshold), or the like. In this scenario, the selections of all the language models of the cluster may be combined. For example, an average ranking or aggregation of the application lists from each LLM may be calculated to derive the overall cluster selection.

For example, the list may be averaged over the different LLM engines of the cluster, and may comprise a reduced and more focused list of client applications per CVE. For example, in case twenty client applications match a CVE, as may be indicated by the NVD, the list may be reduced to five applications thereof that were found to be targeted by exploitation attempts of the CVE.

In certain exemplary embodiments, applications for which a greatest number of attempted exploitations of the CVE are identified in the logs, as estimated attacks that target the applications, may be classified as the most vulnerable applications with respect to the CVE. In some cases, the classification may not depend on the number of attempted exploitations, but rather on a weighted calculation that takes into account the risk of each attempted exploitation, the success rate of the identified attempts, the potential impact of the attempted exploitations, or the like.

According to certain exemplary embodiments, along with the prompting technique, the application model may employ a second technique (denoted “RAG” in FIG. 3). In some exemplary embodiments, the embedding technique may comprise a Retrieval-Augmented Generation (RAG) technique, in which the CVE data (e.g., from the NVD) is embedded to a numerical vector, separately at each language model of a cluster. For example, the CVE data may comprise a name of the CVE, details thereof, a description thereof, or the like. In some exemplary embodiments, the embedding technique may utilize the same or different cluster than the one used for the prompting technique. For example, the cluster may comprise at least two LLM engines, trained on different datasets.

In certain exemplary embodiments, embedding is a tool used to represent and compare text semantically, allowing for semantic similarity search. For example, LLMs may use embeddings to represent text with dense vector representations that represent the relationships between words, phrases, or documents. In some exemplary embodiments, the vector representations may capture the semantic meaning of the text in a numerical form. For example, the language models of the cluster may embed the CVE's textual data by representing its text tokens using one or more numerical vectors. For example, each LLM of the cluster may represent the CVE data by tokenizing the text into smaller units and mapping them to numerical vectors using embeddings. In some cases, the numerical vectors of CVE data may represent the context and meaning of the CVE data.

In some cases, since the language models of the cluster are trained on different datasets, the numerical vectors generated by the language models to represent the CVE data may differ from one another. For example, in case the cluster comprises different LLM engines such as ChatGPT™, BARD™, and Deepseek™, each engine may output a different embedding for the same CVE data.

According to certain exemplary embodiments, in order to map the CVE data to a knowledge source such as a database of adversary tactics or TTPs, the database may also be converted into embeddings similarly to the CVE data. For example, one or more databases such as the MITRE ATT&CK database and Vendors Intelligence databases may be converted, as part of a preprocessing stage, to embed each entry of the databases to one or more numerical vectors. In other cases, any other vectorized databases may be used. For example, the MITRE ATT&CK database may be used without using Vendors Intelligence databases.

In some cases, the vectorized databases may be embedded and stored separately for each LLM engine of the cluster, using the respective LLM engine. In other cases, the vectorized databases may be processed and embedded once using a single type of LLM engine. In some cases, instead of vectorizing the databases, a prepared embedding of databases, in their vectorized form, may be obtained from a third party, e.g., from remote source, a server, a cloud, or the like. In other cases, any other knowledge source or database may be embedded instead of or in additional to the MITRE ATT&CK database and/or the Vendors Intelligence databases.

In certain exemplary embodiments, after the textual data of both the CVE data and the vectorized databases are embedded to numerical vectors, a semantic similarity search may be performed. As part of the semantic similarity search, the vector of the CVE data may be compared to database vectors in order to find semantic matchings. For example, the vector of the CVE data may be compared with vectors of the MITRE ATT&CK database and with vectors of a Vendors Intelligence database using techniques such as cosine similarity, Euclidean Distance, Manhattan Distance, or any other distance metrics that can be used for matching vectors in a multi-dimensional space. As another example, a search algorithm may perform a query search of the vector of the CVE data in the databases, to retrieve the most contextually similar matches.

According to exemplary embodiments, assessing the semantic or contextual matching between the embedded CVE data and embedded TTP data of the MITRE ATT&CK may enable to identify entries in the MITRE ATT&CK database that represent adversary tactics that are semantically most similar to the embedded CVE data. In some exemplary embodiments, assessing the semantic or contextual matching between the embedded CVE data and embedded APT data of the Vendors Intelligence database may enable to identify entries in the Vendors Intelligence database that represent threat actors that are semantically most similar to the embedded CVE data.

In certain exemplary embodiments, entries identified by the vector search of the embedding technique may be selected and extracted from the respective database in case the similarity between their vectors and the embedded CVE data is scored highest, is greater than a threshold, is one of the top highest scoring matches (e.g., the top give matches or any other defined number), or the like. For example, the top ten matches of each LLM engine of the cluster may be extracted. In some exemplary embodiments, an average or consensus calculation may be conducted to merge or intersect the outputs from various LLM engines within the cluster.

For example, the top ten TTP matches averaged over all the LLM engines may be determined as the most relevant TTPs for the CVE, and the top ten APT matches averaged over all the LLM engines may be determined as the most relevant APTs for the CVE. According to this example, the scoring of client applications may be performed according to the top ten TTP and APTs matches, as selected and/or averaged by the entire cluster. In other cases, any other number of matches may be extracted from each database, such as according to an average score in the cluster, a threshold, or the like.

According to certain exemplary embodiments, as part of a post-processing stage of the embedding technique, a mapping of the CVE to client applications may be refined beyond the direct CVE-to-application lookups, based on a consensus or the average highest scoring APTs and TTPs that were found for the CVE. In some exemplary embodiments, using the embedding technique, the highest scoring adversary tactics and threat actors of each engine in the cluster may be intersected, combined, or the like, to identify which client applications are most likely to be targeted by the highest scoring threat actors using the highest scoring adversary tactics. For example, client applications may be scored according to whether or not the highest scoring TTPs are likely to be used by the highest scoring threat actors to target them, based on whether or not the client data reflect such targeting (e.g., as estimated by the language models), or the like. In some cases, the prompting technique may be utilized as part of the post-processing stage of the embedding technique, such as by prompting one or more language models to map the CVE to client applications based on the highest scoring APTs and TTPs, based on user logs, or the like.

In certain exemplary embodiments, after one or more techniques are implemented by one or more respective clusters of language models, the outputs of the techniques may be intersected, combined, averaged, or the like, to estimate an overall vulnerability score of client applications to exploitations of the CVE. In some exemplary embodiments, combining results of one or more clusters of different LLM engines, using both the prompt and the embedding techniques, may enable to identify highly accurate correlations of client applications with the CPE data.

Referring now to FIG. 4, there is illustrated an exemplary model for mapping of CVE data to adversary tactics, as performed by the threat correlation engine (for example as part of step 140 of method 100).

According to certain exemplary embodiments, it may be desired to correlate the vulnerable applications of a CVE (as identified in FIG. 3, for example as part of step 130 of the method 100), with the most likely adversary tactics that can exploit the CVE to target the applications. In some exemplary embodiments, the model of FIG. 4, also referred to as the “TTP model” may utilize the above prompting and embedding techniques to identify, for each CVE, the most relevant TTPs or attempted exploitations of the CVE. In some exemplary embodiments, the threat correlation engine may intersect the prompting and embedding techniques, each using at least one language model cluster, in order to extract the most relevant TTPs per CVE.

In certain exemplary embodiments, when using the prompting technique, the model may ask a cluster of language models, using a defined prompt, to extract the most relevant TTPs per CVE. For example, each LLM engine of the cluster may be instructed to estimate which TTPs are most likely to be used to exploit the CVE, in view of the client data, the CVE data, the client applications that were found in FIG. 3 to be vulnerable to the CVE, the extracted APT data that matches the CVE, in view of TTPs that correspond to each extracted APT, or the like. In some cases, the prompt to each engine may or may not incorporate client data such as security logs. In some exemplary embodiments, in response to the prompt, each language model or the cluster may provide its own list of top TTPs. Based on these individual lists, an overall selection of top TTPs for the entire cluster may be determined.

According to certain exemplary embodiments, along with the prompting technique, the model may employ the embedding technique (denoted “RAG” in FIG. 4) to perform a semantic similarity search between different text embeddings. For example, the textual data of both the CVE data and the MITRE ATT&CK database may be embedded to numerical vectors, and a semantic similarity search of the vector of the CVE data may be performed in order to find TTP entries with the highest semantic matching in the embedded database.

In certain exemplary embodiments, after both techniques are implemented by one or more respective clusters of language models, the outputs of the techniques may be intersected, similar to FIG. 3, to extract an overall matching of TTPs to the CVE. In some exemplary embodiments, combining results of one or more clusters of different LLM engines, using different techniques such as the prompt and the embedding techniques, may enable to identify highly accurate correlations of TTPs with the CPE data, with high confidence.

Referring now to FIG. 5, there is illustrated an exemplary model for mapping adversary tactics to threat actors, as performed by the threat correlation engine (for example as part of step 150 of method 100).

According to certain exemplary embodiments, it may be desired to correlate the adversary tactics that were found (e.g., by FIG. 4, for example as part of step 140 of the method 100) for the vulnerable applications of a CVE (e.g., of FIG. 3, for example as part of step 130 of the method 100), with the most likely threat actors. For example, although API calls can query Vendors Intelligence databases with CVE data and obtain a list of threat actors that are generally associated to the CVE, such a list may be general and may not reflect whether the APTs targeted the vulnerable client applications with exploitation attempts of the CVE. In some exemplary embodiments, APTs that targeted the vulnerable client applications with exploitation attempts of the CVE may be considered more relevant than other APTs of the CVE.

In certain exemplary embodiments, the model of FIG. 5, also referred to as the “APT model”, may utilize the above prompting and/or embedding techniques to identify, for each CVE, the most relevant threat actors. For example, in case the Vendors Intelligence database provides a list of twenty AP Ts per CVE, the list may be reduced to five APTs that are actually relevant as they attempted to exploit the CVE of the client applications, as may be reflected in the client data.

According to certain exemplary embodiments, for each TTP that was identified in FIG. 4, one or more threat actors (or APTs) that are most likely the attacker behind the TTP may be identified. In some exemplary embodiments, the threat correlation engine may intersect the prompting and embedding techniques, each using at least one same or different language model cluster, in order to extract the threat actors that are most likely behind the TTP attack of the client applications. In other cases, only the prompting technique may be used.

For example, the prompting technique may instruct a cluster of language models, using a defined prompt, to extract the most relevant APTs per identified TTP of FIG. 4. For example, each LLM engine of the cluster may be instructed to estimate which APTs that are most likely behind the queried TTP. For example, the prompt may be incorporated with contextual data, including the security logs of the client that reflect the TTP, data regarding the TTP, other client data, CVE data, the extracted APT data from the Vendors Intelligence database, the TTPs that were found for the CVE on FIG. 4, client applications that were found on FIG. 3, or the like.

As another example, the embedding technique may be utilized to query one or more vectorized databases such as the MITRE ATT&CK database, Vendors Intelligence databases, or the like, e.g., similar to FIG. 3. In some exemplary embodiments, the vectorized databases may be queried with a vector representing the TTP data (from FIG. 4). For example, data regarding the adversary tactic may be embedded as a numerical vector, and a semantic similarity search of the vector may be performed within the embedded databases to find the highest-matching APT and/or TTP entries that are contextually most similar to the embedded TTP. In some exemplary embodiments, the highest matching entries may be processed, e.g., statistically, to identify which threat actors (APT entries of the vectorized databases) are most likely associated with a given TTP, and therefore are most likely behind such an attack. In other cases, any other vectorized databases may be used. For example, one or more Vendors Intelligence databases may be used without using the MITRE ATT&CK database.

In certain exemplary embodiments, outputs of the prompting and/or embedding techniques (each of which representing an intersection of different cluster LLM engines) may be intersected, to identify the most relevant APTs according to prompting and/or embedding techniques. For example, the most relevant APTs may comprise APTs that are most likely to be behind TTPs that are reflected in the security logs.

Referring again to FIG. 2, outputs from FIGS. 3-5 may be obtained and processed by the threat correlation engine.

According to certain exemplary embodiments, for each CVE of the of the client applications, the threat correlation engine may query the application model to obtain a list of the most vulnerable client applications to the CVE. In case no client application is found to be vulnerable to the CVE, the CVE may not be processed by the threat correlation engine in subsequent steps.

In certain exemplary embodiments, client applications that are found to be vulnerable by the application model, may be processed and their CVEs may be extracted and processed. For example, CVEs of non-vulnerable client applications may not be processed. In some exemplary embodiments, CVEs of the vulnerable client applications may be iteratively processed by the TTP model, such as in order to obtain, for each such CVE, the top TTPs that were used to target the vulnerable client applications using the CVE.

In some exemplary embodiments, each TTP that is identified by the TTP model, may be iteratively fed as an input to the APT model, in order to obtain the most likely threat actors behind the TTP.

In certain exemplary embodiments, combining the results from the different models of FIGS. 3-5 may provide full exposure paths that link threat actors, to TTPs, to CVEs of vulnerable client applications.

According to certain exemplary embodiments, in order to generate a roadmap, the outputs from the models may be fed to the remediation model, together with additional client data representing current settings and security configurations of the client devices. For example, the additional client data may comprise firewall configurations, firewall version and type, digital assets or machines that are configured to be protected by the firewall configurations, configurations of other security systems, security measures, or the like. For example, the roadmap may be generated according to step 150 of the method 100 illustrated in FIG. 1.

The present disclosed subject matter may be a system, a method, and/or a computer program product. The computer program product may include a computer readable storage medium (or media) having computer readable program instructions thereon for causing a processor to carry out aspects of the present disclosed subject matter.

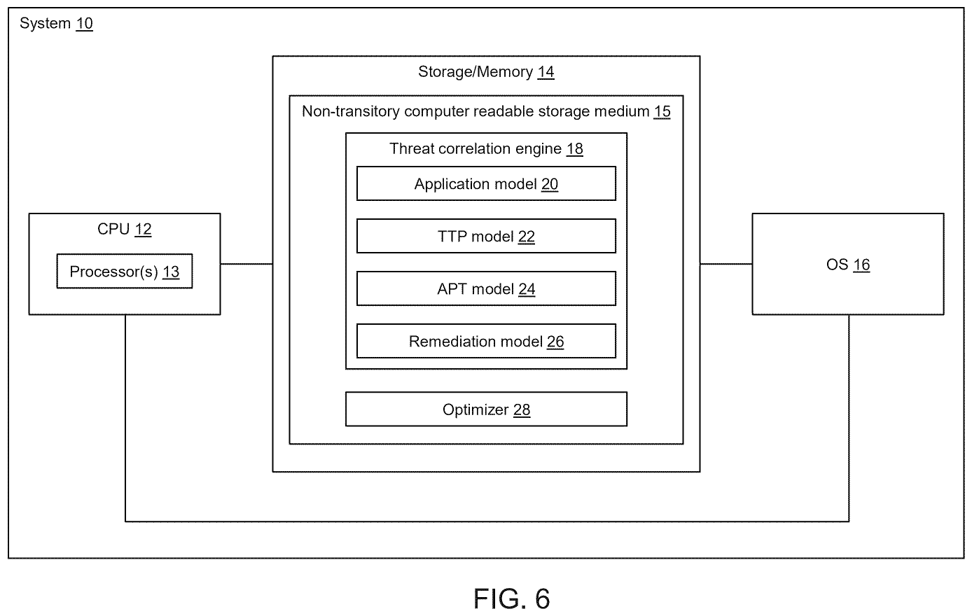

FIG. 6 illustrates an exemplary architecture of a system 10 according to an embodiment of the present disclosure. The system 10 is configured to execute the methods (e.g., 100) of the present disclosure. The system 10 includes a central processing unit (CPU) 12, a storage/memory 14, and an operating system (OS) 16. The CPU 12 is formed from one or more computerized processors 13. The processor(s) 13 can, for example, be conventional processors, such as those used in servers, computers, and other computerized devices. For example, the processor(s) 13 may include x86 Processors from AMD and Intel, Xeon® and Pentium® processors from Intel, as well as any combinations thereof.

The CPU 12 is electronically coupled (connected) to the storage/memory 14, which is configured for storing machine executable instructions, executable by the processor(s) 13 of the CPU 12, for causing the system 10 to execute the methods (e.g., 100) of the present disclosure, as described in detail above. The storage/memory 14, although shown as a single component for representative purposes, may be multiple components. Preferably at least one of the components of the storage/memory 14 is in the form of a non-transitory computer readable storage medium which stores the various models and components (for example as instructions in the form of computer modules) of the present disclosure described above. For example, in the illustrated embodiment, a non-transitory computer readable storage medium 15 of the storage/memory 14 stores the aforementioned threat correlation engine (designated 18) and its aforementioned plurality of models, including the aforementioned first (“application”) model (designated 20), second (“TTP”) model (designated 22), third (“APT”) model (designated 24), and remediation model (designated 26). The non-transitory computer readable storage medium 15 also stores the aforementioned optimizer (e.g., CSI, designated 28). The non-transitory computer readable storage medium 15 may also store additional modules for executing other functions of the present disclosure.

The CPU 12 is further electronically coupled (connected) to OS 16, which may load machine executable instructions, stored in the storage/memory 14, for execution by the CPU 12. The OS 16 may include any of the conventional computer operating systems, such as those available from Microsoft of Redmond Washington, commercially available as Windows® OS, such as Windows® 10, Windows® 7, MAC OS from Apple of Cupertino, CA, or Linux, or may include real-time operating systems. It is noted that although not illustrated in FIG. 6, it will be appreciated that the system 10 may further include, or may be linked to, additional components, such various APIs, network interfaces, user interfaces, and the like, for carrying out aspects of the present disclosure.

The computer readable storage medium (e.g., 15) can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosed subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosed subject matter.

Aspects of the present disclosed subject matter are described herein with reference to flowchart illustrations and/or block diagrams of methods, apparatus (systems), and computer program products according to embodiments of the disclosed subject matter. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosed subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the disclosed subject matter. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosed subject matter has been presented for purposes of illustration and description, but is not intended to be exhaustive or limited to the disclosed subject matter in the form disclosed. Many modifications and variations will be apparent to those of ordinary skill in the art without departing from the scope and spirit of the disclosed subject matter. The embodiments were chosen and described in order to best explain the principles of the disclosed subject matter and the practical application, and to enable others of ordinary skill in the art to understand the disclosed subject matter for various embodiments with various modifications as are suited to the particular use contemplated.

To the extent that the appended claims have been drafted without multiple dependencies, this has been done only to accommodate formal requirements in jurisdictions which do not allow such multiple dependencies. It should be noted that all possible combinations of features which would be implied by rendering the claims multiply dependent are explicitly envisaged and should be considered part of the invention.

What is claimed is:

1. A computer-implemented method comprising:
obtaining vendor data comprising Common Vulnerabilities and Exposures (CVE) data, adversary tactics data, and threat actor data;
obtaining client data of a client;
semantically correlating a CVE of the CVE data with client applications of the client data to identify at least one client application vulnerable to exploitation attempts of the CVE;
semantically correlating the CVE with adversary tactics of the adversary tactics data to identify at least one adversary tactic used to exploit the at least one client application;
semantically correlating the at least one adversary tactic with threat actors of the threat actor data to identify at least one threat actor that utilizes the at least one adversary tactic, thereby identifying at least one exposure path from a threat actor to a vulnerable client application; and
generating a remediation roadmap for the client based on the at least one exposure path.

2. The method of claim 1, wherein at least one of the semantically correlating is performed by a threat correlation engine comprising a plurality of language models, each language model of the plurality of language models being a cluster of language models.

3. The method of claim 2, wherein at least one of the semantically correlating is performed by intersecting results from the plurality of language models to obtain a final result.

4. The method of claim 1, wherein at least one of the semantically correlating is performed by a plurality of language models using a prompting technique, wherein the language models are provided with a prompt comprising contextual data from the vendor data and the client data.

5. The method of claim 1, wherein at least one of the semantically correlating is performed by a plurality of language models using an embedding technique, the embedding technique including: converting textual data from at least one of the vendor data or the client data into a numerical vector, and performing a semantic similarity search of the numerical vector to identify a contextual matching.

6. The method of claim 1, wherein the client data includes one or more of security logs, system logs, configuration files, configuration settings, a list of client applications, or components of client applications.

7. The method of claim 1, wherein the vendor data is obtained from at least one of an NVD database, a MITRE ATT&CK database, or a Vendors Intelligence database.

8. The method of claim 1, wherein the remediation roadmap is generated based on a prioritization process that assigns a risk score to the at least one exposure path.

9. The method of claim 8, wherein the prioritization process is performed by a remediation model that uses a cost function, the cost function taking into account a severity of the CVE, an importance of the at least one client application, and a likelihood of exploitation.

10. The method of claim 8, wherein the prioritization process further includes filtering out exposure paths that have a risk score below a predetermined threshold.

11. The method of claim 1, further comprising: optimizing resource allocation for remediations, using an optimizer to globally minimize the cost of the remediations.

12. The method of claim 1, further comprising: filtering out an exposure path that is not relevant in view of security controls and configurations of the client.

13. A computer system comprising:
a computerized processor; and
a non-transitory storage medium for storing instructions that, when executed by the computerized processor, cause the system to:
obtain vendor data comprising Common Vulnerabilities and Exposures (CVE) data, adversary tactics data, and threat actor data,
obtain client data of a client,
semantically correlate a CVE of the CVE data with client applications of the client data to identify at least one client application vulnerable to exploitation attempts of the CVE,
semantically correlate the CVE with adversary tactics of the adversary tactics data to identify at least one adversary tactic used to exploit the at least one client application,
semantically correlate the at least one adversary tactic with threat actors of the threat actor data to identify at least one threat actor that utilizes the at least one adversary tactic, thereby identifying at least one exposure path from a threat actor to a vulnerable client application, and
generate a remediation roadmap for the client based on the at least one exposure path.

14. The computer system of claim 13, wherein the non-transitory storage medium stores instructions for a threat correlation engine comprising a plurality of language models, such that when executed by the computerized processor, a first model of the threat correlation engine semantically correlates the CVE with the client applications, a second model of the threat correlation engine semantically correlates the CVE with the adversary tactics, and a third model of the threat correlation engine semantically correlates the at least one adversary tactic with the threat actors.

15. The computer system of claim 14, wherein the first, second, and third language models each include a cluster of language models.

16. The computer system of claim 14, wherein the first, second, and third language models is each configured to be provided with a prompt comprising contextual data from the vendor data and the client data, and wherein the first, second, and third language models is each configured to perform sematic correlation using a prompting technique.

17. The computer system of claim 13, wherein the first, second, and third language models is each configured to perform sematic correlation by: converting textual data from at least one of the vendor data or the client data into a numerical vector, and performing a semantic similarity search of the numerical vector to identify a contextual matching.

18. The computer system of claim 13, wherein the non-transitory storage medium stores instructions for a threat correlation engine comprising a remediation model, such that when executed by the computerized processor, the remediation model generates the remediation roadmap.

19. The computer system of claim 18, wherein the remediation model is further configured to perform a prioritization process that assigns a risk score to the at least one exposure path, and to generate the remediation roadmap based on the prioritization process.

20. A computer usable non-transitory storage medium having a computer program embodied thereon for causing a suitably programmed system to perform the following steps when such program is executed on the system, the steps comprising:
obtaining vendor data comprising Common Vulnerabilities and Exposures (CVE) data, adversary tactics data, and threat actor data;
obtaining client data of a client;
semantically correlating a CVE of the CVE data with client applications of the client data to identify at least one client application vulnerable to exploitation attempts of the CVE;
semantically correlating the CVE with adversary tactics of the adversary tactics data to identify at least one adversary tactic used to exploit the at least one client application;
semantically correlating the at least one adversary tactic with threat actors of the threat actor data to identify at least one threat actor that utilizes the at least one adversary tactic, thereby identifying at least one exposure path from a threat actor to a vulnerable client application; and
generating a remediation roadmap for the client based on the at least one exposure path.
